(19) United States
(12) Patent Application Publication
(10) Pub. No.: US 2005/0122509 A1
(43) Pub. Date: Jun. 9, 2005

(54) Apparatus for wafer inspection

(75) Inventor: Henning Backhauss, Wetzlar (DE)

Correspondence Address: DAVIDSON, DAVIDSON & KAPPEL, LLC, 485 SEVENTH AVENUE, 14TH FLOOR, NEW YORK, NY, 10018, US

(73) Assignee: Leica Microsystems Semiconductor GmbH, Wetzlar (DE)

(21) Appl. No.: 11/037,668

(22) Filed: Jan. 18, 2005

Related U.S. Application Data
(63) Continuation of application No. PCT/EP03/07677, filed on Jul. 16, 2003.

(30) Foreign Application Priority Data
Jul. 18, 2002 (DE) 102 32 781.5

(51) Int. Cl. G01N 21/88

(52) U.S. Cl. 356/237.2

(57) ABSTRACT

An apparatus for wafer inspection includes an incident-light illumination device having an illumination axis, and an imaging device having an imaging axis. The illumination and imaging axes are inclined with respect to each other and directed onto a region to be inspected of the surface of a wafer. The illumination and imaging axes define an image plane spanned by the illumination and imaging axes in a bright-field illumination setting of the apparatus. The illumination axis is rotatable out of the image plane to a dark-field angle so as to provide a dark-field illumination in the region to be inspected.

### CROSS REFERENCE TO RELATED APPLICATIONS

This application is a continuation of International Application No. PCT/EP2003/007677, filed Jul. 16, 2003, which claims priority to German patent application 102 32 781.5, filed Jul. 18, 2002. The entire disclosure of each of these applications is hereby incorporated by reference herein.

### FIELD OF THE INVENTION

The invention concerns an apparatus for wafer inspection, having an incident-light illumination device having an illumination axis and an imaging device having an imaging axis, both of which are directed onto a region to be inspected of the surface of a wafer.

### BACKGROUND OF THE INVENTION

In semiconductor production, wafers are coated with photoresist during the production process. The photoresist passes first through an exposure process and then a development process. In these processes, it is patterned for subsequent process steps. For production-related reasons, slightly more photoresist becomes deposited in the edge regions of the wafer than in the middle of the wafer. An “edge bead” is thereby formed. The photoresist at the edge of the wafer, and the edge bead, can lead to contamination of production machinery and create defects on the wafer in subsequent process steps.

To eliminate these effects, an edge bead removal (EBR) process is performed. Errors in the width of the edge bead removal derive from inaccurate alignment of the corresponding edge beam removal devices relative to the wafer. Further error sources include inaccurate alignment of the illumination devices relative to the wafer upon exposure of the photoresist. Excessive edge bead removal results in a decrease in the usable wafer area, and thus in a loss of chip production. Insufficient edge bead removal can result, in the edge region of the wafer, in contamination of the subsequently applied resist layers or other features. Since the productivity of the production process is diminished in both cases, edge bead removal (along with many other defects) is continuously monitored during the production process. The edge beam removal width is monitored, and a check is made as to whether edge bead removal has in fact taken place.

Devices are known which, by image recognition, detect a wide variety of features on the surface of a wafer. In this context, the wafer is illuminated in bright-field fashion and scanned with a camera (matrix camera or linear camera).

One such inspection machine of KLA-Tencor Corporation is described in the article “Lithography Defects: Reducing and Managing Yield Killers Through Photo Cell Monitoring,” by Ingrid Peterson, Gay Thompson, Tony DiBiase, and Scott Ashkenaz, Spring 2000, Yield Management Solutions. The wafer inspection device described therein operates with an incident-light illumination device that examines low-contrast microdefects using bright-field illumination.

In the known apparatuses for wafer inspection, the image processing system cannot easily make a distinction between the edge bead removal (EBR) and the other edges present in the image. These other edges derive from previous process steps. In bright-field illumination, all the edges are different in terms of color or grayscale value. Since the different edges also intersect or overlap in some cases, the color or grayscale value of the edges also changes. It is therefore very difficult or impossible to filter out the edge bead removal in this fashion using an image processing system. Even a visual inspection by an observer produces no better results, since the human eye also cannot manage to allocate the various edges and observed colors or grayscale values to the various process steps.

### SUMMARY OF THE INVENTION

It is therefore an object of the present invention to provide an apparatus with which the edge generated by edge bead removal is reliably made visible, so that it is distinguishable from other edges visible on the wafer.

The present invention provides an apparatus for wafer inspection having an incident-light illumination device having an illumination axis and an imaging device having an imaging axis, both of which are inclined with respect to one another and are directed onto a region to be inspected of the surface of a wafer. An image plane is defined by the fact that, in the bright-field illumination setting of the apparatus, it is spanned by the illumination axis and the imaging axis. According to the present invention, the apparatus is characterized in that the illumination axis is arranged rotated out of the image plane by an amount equivalent to a dark-field angle γ>0, in such a way that a dark-field illumination exists in the region to be inspected.

A transition from bright-field illumination to dark-field illumination is thus achieved when the 0° setting is exceeded. The quality of the dark-field illumination increases for greater dark-field angles γ. Selection of the dark-field angle γ depends on the diffusion behavior of the surface structure and the surface materials of the wafer or of the previously patterned or coated wafer.

With this apparatus it is possible to inspect especially effectively, on the entire wafer, those (predominantly small) features that are distinguished from the background or surroundings by slight height differences, and that are undetectable or very poorly detectable using the bright-field illumination configuration known from the existing art. For example, edge breaks and edge irregularities of the wafer edge can be examined. In addition, identification codes applied on the wafer can be examined using the apparatus according to the present invention.

With the dark-field illumination achieved in this fashion, the EBR edge can reliably be made visible in the edge region of the wafer, since it is visible in the image as a substantially brighter line than the edges of previous process steps. In the context of alignment of the apparatus, it proves to be advantageous when the illumination axis and the imaging axis intersect in the incidence point at which the imaging axis strikes the wafer. An acceptable dark-field illumination can still be generated, however, even in those cases in which the illumination axis extends slightly outside the incidence point. It is important that light from the illuminated region of the wafer surface still passes into the image beam path. The particular setting depends in each case on the properties of the surface being examined (diffusion behavior, material, features, etc.).

The image plane can likewise, in principle, be inclined with respect to the wafer surface. In physical terms, however, it proves to be simpler when the image plane is perpendicular to the wafer surface, since alignment of the apparatus is thus simpler.

A number of possibilities also exist for aligning the imaging axis relative to the wafer. For example, the imaging axis can coincide with a wafer normal line through the incidence point; in other words, the imaging axis extends collinearly with the wafer normal line. In illustrative terms, this means that the imaging axis of the imaging device, for example a camera, is directed perpendicularly from above onto the wafer. This can also be achieved when the imaging device itself is arranged laterally, and when the image beam path with the imaging axis is coupled laterally into the apparatus via an optical incoupling element (e.g. mirror, prisms, etc.). The imaging axis is then deflected by the incoupling element in such a way that it extends collinearly with the wafer normal line.

It is likewise possible to arrange the imaging axis at an inclination, by an amount equal to an imaging angle β>0, with respect to the wafer normal line through the incidence point. In this case the best image properties are obtained when the imaging angle β is equal to the illumination angle α; in this embodiment of the apparatus, the illumination angle α is defined by the inclination of the illumination axis with respect to the wafer normal line through the incidence point. It has been found that a good depiction of the previously removed edge photoresist (EBR edge) in dark field is achieved when the dark-field angle Γthrough which the illumination axis is rotated out of the image plane assumes values preferably between 5° and 45°, i.e. when 5°<γ≦45°.

The illumination device can be equipped both with a polychromatic and with a monochromatic light source. The light source can thus, for example, be a pressurized mercury vapor lamp or a cold light source having an attached fiber bundle for transferring the light. The use of an LED or of a laser with beam spreading is also conceivable. Both a divergent and a convergent illumination beam path can be used. In a preferred embodiment, a telecentric illumination beam path is preferred, slight deviations from strictly telecentric beam guidance being permissible with no loss of illumination quality.

The imaging device usually comprises an objective and a camera or linear camera array, arranged thereafter, onto which the region to be inspected is imaged. Depending on the linear magnification (which is defined by the objective), regions of different size can therefore be inspected using the camera image.

For the inspection of wafer defects in the region of the wafer edge, it is preferable to use an imaging device which encompasses an objective and a linear camera. An optimum dark-field depiction of the edge of edge-bead-removed photoresist layers is obtained when the dark-field illumination is accomplished by inclining the incident-light illumination device away from the center region of the wafer toward the wafer edge.

Alignment marks on the wafer, or prominent edge structures such as the so-called flat or notch, can be used as a reference point for the localization of observed defects. For simplification, however, the wafer edge itself is preferably used. To make that wafer edge more visible, in an advantageous embodiment of the apparatus a wafer underside illumination device, which is positioned beneath the wafer in the region of the wafer edge, is additionally arranged. This wafer underside illumination device radiates from below beyond the wafer edge, and illuminates the imaging device. A prominent light/dark transition that exactly reproduces the wafer edge is therefore visible in the camera image or in the camera line.

In order to allow an inspection of the entire wafer edge, the wafer is placed onto a receiving device that is rotatable about its center. For automated inspection of the wafer edge, this receiving device is coupled to a motorized drive system which performs an exact rotation of the receiving device. For automatic inspection of the edge region of the wafer, the apparatus has associated with it a data readout device which sequentially reads out the image data of the linear camera during the rotational motion of the wafer on the receiving device. A computer that is connected to the apparatus controls the motorized drive system and the data readout device. Alternatively, an encoder is provided that triggers the camera and/or the data readout device (e.g. frame grabber).

From the image data acquired sequentially during rotation of the wafer, various parameters or defects can then be determined using the computer. For example, the location of the so-called wafer flat or also the location of the so-called wafer notch on the wafer edge can be determined.

For determination of the location and quality of the edge bead removal (EBR) for the wafer, the wafer is rotated at least once through 360°. The image data acquired sequentially during this rotation are evaluated, the brightest line in the image (or the brightest pixel in the image, in the case of a linear camera) identifying the location of the EBR edge. In contrast thereto, the edges of previous process steps appear only as low-intensity lines, or pixels in the linear camera. From the location of the EBR edge relative to the wafer edge which is made visible by the wafer underside illumination device, the extent of the edge bead removal and its deviations from target values relative to the wafer edge can be determined.

### BRIEF DESCRIPTION OF THE DRAWINGS

The apparatus according to the present invention is explained more thoroughly below with reference to the schematic drawings. In the individual Figures:

FIG. 1 is a plan view of an apparatus for wafer inspection in the entire wafer region;

FIG. 2 is a side view of an apparatus for wafer inspection on the entire wafer region;

FIG. 3 is a plan view of an apparatus for wafer inspection of the wafer edge or edge bead removal area;

FIG. 4 is a side view of an apparatus for wafer inspection of the wafer edge or edge bead removal area;

FIG. 5 is a side view, rotated 90° with respect to FIG. 4, of an apparatus for wafer inspection of the wafer edge or edge bead removal area;

FIG. 6 is a three-dimensional arrangement of an apparatus for wafer inspection in the region of the wafer edge, or for inspection of the edge bead removal area.

### DETAILED DESCRIPTION OF THE INVENTION

In order to simplify the depiction, in the examples shown below an imaging axis was selected which runs perpendicular to the wafer surface. This proves simpler in terms of both illustration and design, since the apparatus is easier to align.

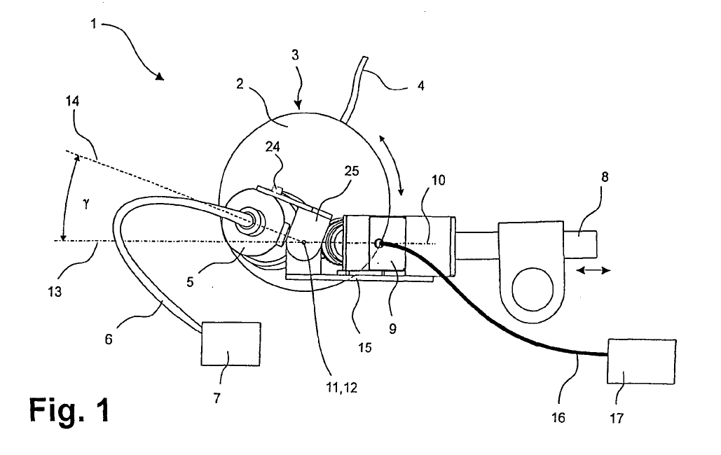

FIG. 1 shows an apparatus 1 for wafer inspection having a wafer 2 to be inspected. Wafer 2 is placed onto a receiving device 3 (concealed in this depiction) that retains wafer 2 by means of vacuum suction. The necessary vacuum is conveyed to receiving device 3 by means of a vacuum line 4 that is connected to a vacuum system (not depicted) for generating the vacuum.

An incident-light illumination device 5, which has its light conveyed to it via a light guide bundle 6 from a light source 7, is directed onto a region of wafer 2 to be inspected. Incident-light illumination device 5 is arranged at an inclination with respect to the surface of wafer 2. An imaging device 9 is arranged on a displaceable support element 8. Imaging device 9 has an imaging axis 10. At incidence point 11 of this imaging axis 10 on wafer 2, a wafer normal line 12 is defined, i.e. a construction line that is perpendicular to wafer 2 at incidence point 11. In the depiction, wafer normal line 12 and incidence point 11 are coincident with one another.

In the embodiment of the apparatus for wafer inspection that is shown, imaging axis 10 is inclined with respect to wafer normal line 12, i.e. imaging device 9 is arranged at an inclination with respect to the surface of wafer 2. As a result, imaging axis 10 and wafer normal line 12 span a plane 13 that is represented by a dashed line in the plan view. This plane 13 corresponds to that image plane which, in the bright-field setting of the apparatus, is spanned by imaging axis 10 and illumination axis 14.

Incident-light illumination device 5 has an illumination axis 14 which, according to the present invention, is inclined with respect to plane 13 by an amount equal to illumination angle α. In the embodiment of the apparatus for wafer inspection that is depicted, illumination axis 14 strikes wafer 2 at incidence point 11, i.e. at the same point at which imaging axis 10 also strikes wafer 2. In the present case, therefore, illumination angle α is defined as the inclination of illumination axis 14 with respect to wafer normal line 12. Illumination angle α is set by means of α-adjustment device 24, on which the incident-light illumination device is mounted. α-adjustment device 24 is mounted on a γ-adjustment device 25 which in turn is arranged on support rail 15. It proves to be advantageous when imaging angle β is equal to illumination angle α. A good image is nevertheless also obtained even with a slight difference between illumination angle α and imaging angle β.

Illumination angle α is not directly visible in FIG. 1, but is merely indicated by the fact that a portion of the obliquely extending housing of incident-light illumination device 5 is perceptible. It is clearly evident, however, that illumination axis 14 is rotated out of plane 13 by rotation about wafer normal line 12 by an amount equal to dark-field angle γ.

By suitable selection of dark-field angle γ>0, a dark-field illumination is produced in the region to be inspected on the surface of wafer 2. Dark-field angle γ is set by means of γ-adjustment device 25, which permits incident-light illumination device 5 to pivot about wafer normal line 12. Experiments have shown that in principle, setting dark-field angle γ in the range 0°<γ≦50° yields dark-field illumination. Particularly good settings of the dark field are obtained by selecting dark-field angle γ using angular positions in the range 10°≦γ≦25°. In the present exemplary embodiment, a dark-field angle Γ=20° was selected.

In order to allow different regions of wafer 2 to be inspected, imaging device 9 is displaceable over the wafer surface by displacement of support element 8. Since imaging device 9 and illumination device 5 are rigidly joined to one another via a common adjustable support rail 15, displacement of support element 8 causes the entire apparatus 1 to be displaced over the surface of wafer 2 to the desired region to be inspected. To facilitate the location of any regions to be inspected on the wafer surface of wafer 2, wafer 2 is additionally mounted rotatably on receiving device 3 (not depicted). The rotational motion is symbolically indicated by a curved double arrow. In this context, wafer 2 usually rests immovably on receiving device 3 as a result of vacuum suction, and receiving device 3 itself is configured rotatably.

By suitable displacement of support element 8, incident-light illumination device 5 and imaging device 9 can thus be displaced together, and any desired regions to be inspected on wafer 2 can therefore be examined. The respective image data acquired by imaging device 9, which e.g. comprises an objective and a camera, are transferred via a data line 16 to a data readout device 17.

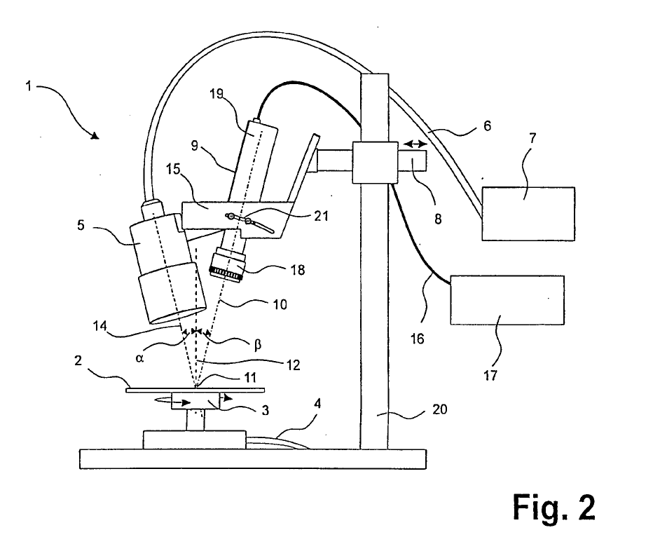

FIG. 2 shows, in a side view, an apparatus 1 for wafer inspection. A receiving device 3, on which a wafer 2 is placed, is arranged on the lower part of a stand 20. Receiving device 3 is supplied with vacuum by means of a vacuum line 4, so that wafer 2 can be held by suction. Receiving device 3 is rotatable about its vertical axis, as indicated by a double arrow. Wafer 2 can also be rotated in this fashion.

An imaging device 9, comprising an objective 18 and a camera 19, is directed onto a region to be inspected on the surface of wafer 2. Imaging device 9 has an imaging axis 10 that is inclined with respect to the surface of wafer 2 and strikes the wafer surface at incidence point 11. A construction line that is perpendicular to the surface of wafer 2 at this incidence point 11 is defined as wafer normal line 12. The inclination of imaging axis 10 with respect to this wafer normal line 12 defines imaging angle β.

An incident-light illumination device 5 is also directed onto the region of the wafer surface to be inspected. Incident-light illumination device 5 possesses an illumination axis 14 that is inclined with respect to wafer normal line 12 by an amount equal to illumination angle α. Note that imaging axis 10 and wafer normal line 12 span a plane 13 that, in the depiction, is coincident with the drawing plane. This plane 13 corresponds to that image plane which, in the bright-field setting of the apparatus, is spanned by imaging axis 10 and illumination axis 14.

Since illumination axis 14 of incident-light illumination device 5 is rotated out of said plane 13 by an amount equivalent to dark-field angle Γ, as depicted in FIG. 1, illumination angle α drawn in FIG. 2 does not correspond at exact scale to the actual illumination angle. Instead, illumination angle α depicted in the drawing plane is shortened by projection of the actual spatial position of illumination axis 14.

Incident-light illumination device 5 is arranged on support rail 15 by means of γ-adjustment device 25, and imaging device 9 is arranged thereon by means of an alignment rail 21, support rail 15 being rigidly joined to support element 8. In the advantageous embodiment of the apparatus shown here, the spatial position of imaging device 9 can be varied and defined by means of alignment rail 21, so that different imaging angles β can be set.

By appropriately selecting illumination angle α and dark-field angle γ, the user of the apparatus can therefore adapt the dark-field illumination to his or her particular problem, e.g. to the size, height, or optical properties (such as contrast, reflectivity, etc.) of the features to be examined. Low-contrast features, in particular, can thus be examined substantially better than with previously known bright-field illumination devices.

Support rail 15, with imaging device 9 mounted thereon, is joined rigidly to a displaceable support element 8 that is mounted on the vertical portion of stand 20. Incident-light illumination device 5 is arranged on a γ-adjustment device (not shown here) which is also joined rigidly to support element 8. Support element 8 is horizontally displaceable, so that the unit made up of incident-light illumination device 5 and imaging device 9 can be displaced together.

In this fashion, by displacing support element 8 it is possible to position incidence point 11 and therefore the dark-field region on any desired regions to be inspected on the surface of wafer 2. To facilitate the location of particular regions to be inspected, wafer 2 can be rotated about a vertical axis by means of the rotatable receiving apparatus 3. The image data generated by the camera during inspection are transferred via a data line 16 to a data readout device 17, where they are available for further processing and evaluation, e.g. by means of a computer.

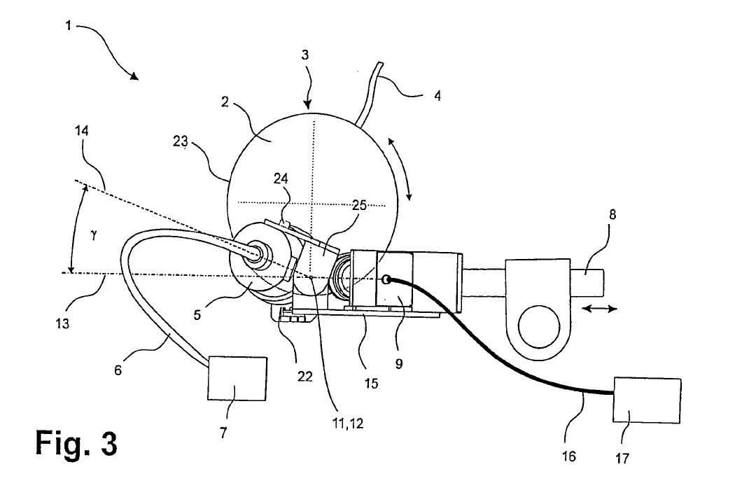

FIG. 3 is a plan view of an apparatus 1 for wafer inspection in which the region to be inspected lies in the region of the wafer edge.

Wafer 2 is placed onto a receiving device 3 (concealed in this depiction) which retains wafer 2 by means of vacuum suction. The necessary vacuum is conveyed to receiving device 3 by means of a vacuum line 4.

An incident-light illumination device 5, which has its light conveyed to it via a light guide bundle 6 from a light source 7, is directed onto a region to be inspected on wafer edge 23 of wafer 2. Incident-light illumination device 5 is arranged at an inclination with respect to the surface of wafer 2. An imaging device 9 is arranged on a displaceable support element 8 by means of a support rail 15. Imaging device 9 has an imaging axis 10. At incidence point 11 of this imaging axis 10 on wafer 2, a wafer normal line 12 is defined, i.e. a construction line that is perpendicular to wafer 2 at incidence point 11. In the depiction shown here, wafer normal line 12 and incidence point 11 are coincident with one another. An optimum dark-field depiction of the edge of edge-bead-removed photoresist layers is achieved by the fact that incident-light illumination device 5 is directed from the center region of wafer 2 toward wafer edge 23.

In the embodiment of the apparatus for wafer inspection that is shown, imaging axis 10 is inclined with respect to wafer normal line 12 by an amount equal to imaging angle β, i.e. imaging device 9 is arranged at an inclination with respect to the surface of wafer 2. As a result, imaging axis 10 and wafer normal line 12 span a plane 13 that is represented by a dashed line in the plan view. This plane 13 corresponds to that image plane which, in the bright-field setting of the apparatus, is spanned by imaging axis 10 and illumination axis 14.

Incident-light illumination device 5 has an illumination axis 14 which, according to the present invention, is inclined with respect to wafer normal line 12 by an amount equal to illumination angle α, and which is rotated out of plane 13 by an amount equal to dark-field angle γ. In the embodiment of the apparatus for wafer inspection that is depicted, illumination axis 14 strikes wafer 2 at incidence point 11, i.e. at the same point at which imaging axis 10 also strikes wafer 2. In the present case, therefore, illumination angle α is defined as the inclination of illumination axis 14 with respect to wafer normal line 12. In the example depicted, illumination angle α is equal to imaging angle β. Illumination angle α is not directly visible in FIG. 3, but is merely indicated by the fact that a portion of the obliquely extending housing of incident-light illumination device 5 is perceptible. It is clearly evident, however, that illumination axis 14 is rotated out of plane 13 by an amount equal to dark-field angle γ.

By suitable selection of dark-field angle γ>0, a dark-field illumination is produced in the region to be inspected on the surface of wafer 2. Dark-field angle γ is set by means of γ-adjustment device 25, which permits incident-light illumination device 5 to pivot about wafer normal line 12.

Experiments have shown that in principle, setting dark-field angle γ in the range γ >0° yields dark-field illumination. Exceeding the 0° setting results in a transition from bright-field to dark-field illumination. The quality of the dark-field illumination increases for greater dark-field angles γ. A good depiction of features in the dark field is obtained by selecting dark-field angle γ using angular positions in the range 5°≦γ≦40°. In the present exemplary embodiment, a dark-field angle γ=20° was selected.

With the embodiment described here of the apparatus for wafer inspection, it is possible in particular to check the edge region of wafer 2 and thus also the removal of the edge bead of photoresist layers. In this context, the location of the outer edge of the photoresist layer that remains after edge bead removal is determined. The location of the edge of this resist layer is indicated in each case relative to a reference point. For example, the position of this edge in the camera image can be indicated in relation to the first pixel of the image or in relation to the first pixel of the respective image line. Alternatively, it is conceivable to select a mechanical stop for the wafer support, or possibly to select an additional alignment mark on wafer 2 as the reference point.

It has proven particularly advantageous, however, to indicate the location of the photoresist edge relative to wafer edge 23. This requires an exact determination of wafer edge 23 of wafer 2 in the image of imaging device 9. With low-contrast images this can be difficult in some circumstances.

For that purpose, the embodiment depicted in FIG. 3 has an additional wafer underside illumination device 22 that is arranged beneath wafer 2 in its edge region. As a result of the background illumination of the underside of wafer 2 generated thereby, a prominent light/dark transition is produced in the camera image along the imaged wafer edge 23. Wafer underside illumination device 22 thus furnishes an exact depiction of wafer edge 23 in the image. The edge of the edge-bead-removed photoresist is then determined by determining the brightest line in the image, referred in each case to the image of wafer edge 23. The distance of the resist edge from wafer edge 23 is then an indication of the edge bead removal. In addition, it is possible to check whether edge bead removal has taken place at all, and whether it was performed completely. The measured edge bead removal values can then be compared to the semiconductor manufacturer's reference production parameters. In the event of deviations, the production processes are appropriately adapted in order to ensure optimum yield in the production process.

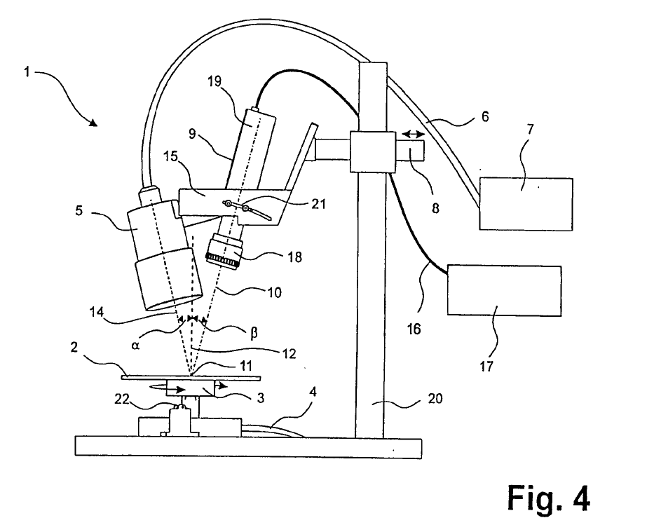

FIG. 4 is a side view of an apparatus for wafer inspection as already depicted in FIG. 3.

A receiving device 3, on which a wafer 2 is placed, is arranged on the lower part of a stand 20. Receiving device 3 is supplied with vacuum by means of a vacuum line 4, so that wafer 2 can be held by suction. Receiving device 3 is rotatable about its vertical axis, as indicated by a double arrow. Wafer 2 can also be rotated in this fashion.

An imaging device 9, comprising an objective 18 and a camera 19, is directed onto an edge region to be inspected on the surface of wafer 2. Imaging device 9 has an imaging axis 10 that is inclined with respect to the surface of wafer 2 and strikes the wafer surface at incidence point 11. A construction line that is perpendicular to the surface of wafer 2 at this incidence point 11 is defined as wafer normal line 12. The inclination of imaging axis 10 with respect to this wafer normal line 12 defines imaging angle β.

An incident-light illumination device 5 is also directed onto the edge region of the wafer surface to be inspected. Incident-light illumination device 5 possesses an illumination axis 14 that is inclined with respect to wafer normal line 12 by an amount equal to illumination angle α. In the present embodiment of the apparatus, illumination angle α is equal to imaging angle β.

Note that imaging axis 10 and wafer normal line 12 span a plane 13 which, in the depiction, is coincident with the drawing plane. This plane 13 corresponds to that image plane which, in the bright-field setting of the apparatus, is spanned by imaging axis 10 and illumination axis 14. Since illumination axis 14 of incident-light illumination device 5 is, according to the present invention, rotated out of said plane 13 by an amount equivalent to dark-field angle γ, as depicted in FIG. 1, illumination angle α drawn in FIG. 4 does not correspond at exact scale to the actual illumination angle α. Instead, illumination angle α depicted in the drawing plane is shortened by projection of the actual spatial position of illumination axis 14.

As already described with reference to FIG. 3, by appropriate selection of dark-field angle γ>0, a dark-field illumination is produced in the edge region to be inspected on the surface of wafer 2. The user of the apparatus can thereby adapt the dark-field illumination to his or her particular problem, e.g. to the size, height, or optical properties (such as contrast, reflectivity, etc.) of the features to be examined. Low-contrast features, in particular, can thus be examined substantially better than with previously known bright-field illumination devices.

Incident-light illumination device 5 is arranged on support rail 15 by means of a γ-adjustment device (not shown here), and imaging device 9 is arranged thereon by means of an alignment rail 21, support rail 15 being rigidly joined to support element 8. In the advantageous embodiment of the apparatus shown here, the spatial position of imaging device 9 can be varied and defined by means of alignment rail 21, so that different imaging angles β can be set.

Support rail 15 is arranged on a displaceable support element 8 that is mounted on the vertical portion of stand 20. Support element 8 is horizontally displaceable, so that the unit made up of incident-light illumination device 5 and imaging device 9 can be displaced together.

By horizontal displacement of support element 8, incidence point 11—and simultaneously the illuminated region—can be positioned on any desired edge regions of wafer 2 that are to be inspected, and can be adapted to different wafer diameters. To facilitate the location of particular edge regions to be inspected, wafer 2 can additionally be rotated about a vertical axis by means of rotatable receiving apparatus 3. The image data generated by the camera during inspection are transferred via a data line 16 to a data readout device 17, where they are available for further processing and evaluation, e.g. by means of a computer (not illustrated).

In the depiction selected here, it is clearly evident that wafer underside illumination device 22 is arranged beneath wafer 2 and at the same time on imaging axis 10. Wafer underside illumination device 22 is thus positioned beneath wafer 2 in such a way that it is imaged directly onto camera 19. For inspection of the wafer edge, it proves advantageous when a linear camera is used as camera 19, and when an LED line with a Fresnel lens in front is used as wafer underside illumination device 22. By exact adjustment of the LED line beneath wafer 2, it is possible for it to be imaged directly and in exact alignment onto the line of linear camera 19.

A wide variety of objectives 18, both telecentric and non-telecentric objectives, can be used in combination with camera 19. One example of a non-telecentric objective is the Rodagon® 1:4/60 mm objective of the Rodenstock Co., Germany, having a focal length F=60 mm, an object field of approx. 0.028 mm×57 mm, linear magnification M=1:2. One example of a telecentric objective is the Sill S5LPF2005 objective of Sill Optics, Wendelstein, Germany.

A variety of parameters can be optimized for the application by selecting the objective and the linear magnification. If applicable, filters and stops (not depicted) can also be introduced into the beam path in order to optimize the dark-field illumination.

The example described here of an apparatus for wafer inspection has as incident-light illumination device 5 a polychromatic cold light source with fiber optics and a telecentric beam path. An easily aligned configuration results from the fact that illumination angle α is selected to be equal to imaging angle β. This is not, however, absolutely necessary for configuring a good dark-field illumination of the region to be inspected on wafer 2, since a good dark-field illumination is achieved for other angular relationships as well.

A complete inspection of the entire wafer edge 23 or of the resist edge located (after edge bead removal) in its vicinity is accomplished by positioning linear camera 19 with respect to the surface of wafer 2 in such a way that an edge region that extends radially on wafer 2 is imaged onto the camera line. In this arrangement, it is preferable when imaging angle β>0°, as shown in the depiction.

For inspection of the entire wafer edge 23, wafer 2 is rotated by rotating receiving device 3 about its vertical rotation axis. During one 360° rotation, data readout device 17, for example a computer with a frame grabber, reads out the linear camera of wafer 2 several times, e.g. at equal intervals. The image data are then evaluated with special software, and the respective location of the photoresist edge with reference to wafer edge 23 is determined therefrom. The location of the wafer flat or wafer notch can also be determined using the same procedure.

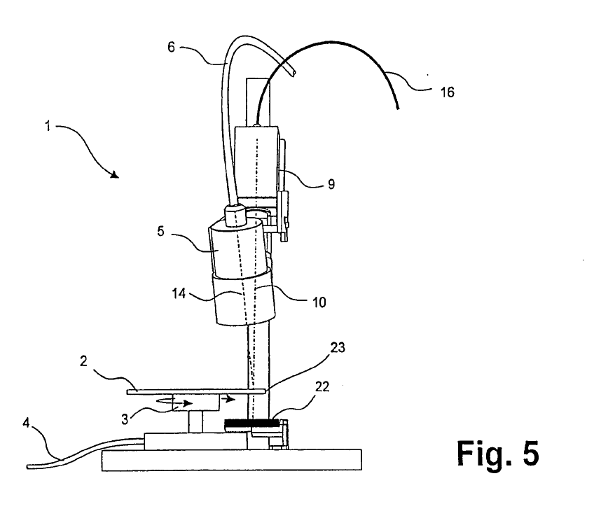

The apparatus for wafer inspection depicted in FIG. 4 is shown in FIG. 5 in a side view, rotated a further 90°. The same apparatus elements are labeled with the same reference numbers.

An imaging device 9 and an illumination device 5, the latter arranged at an inclination according to the present invention, are directed onto a region to be inspected of a wafer 2 in the region of its wafer edge 23. The positioning of wafer underside illumination device 22 beneath wafer edge 23 is clearly evident. Wafer underside illumination device 22 is aligned in such a way that it illuminates wafer 2 from below and radiates beyond its wafer edge 23. The light radiating beyond wafer edge 23 is sensed by imaging device 9 so that in the image which is generated, the boundary of wafer edge 23 appears as a prominent light/dark transition. Evaluation is then performed as already described with reference to FIG. 4.

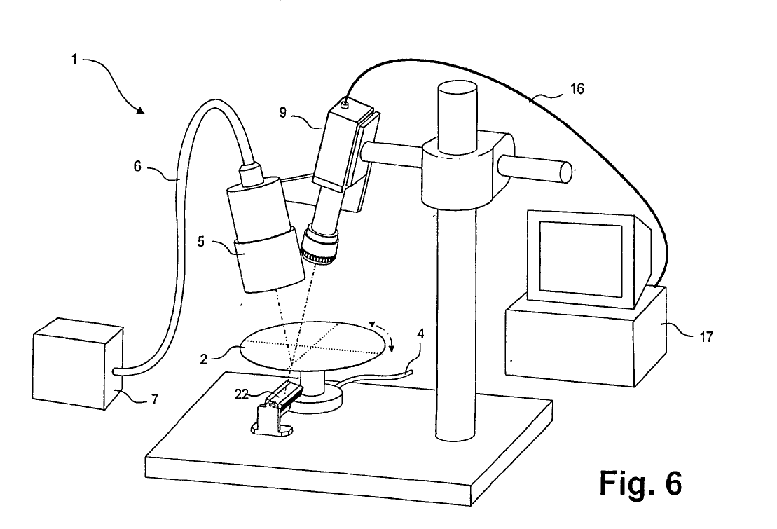

FIG. 6 shows a three-dimensional arrangement of an apparatus for wafer inspection such as the one already described in FIGS. 3, 4, and 5. Identical apparatus elements are labeled with identical reference characters. Here again, imaging device 9 and incident-light illumination device 5, the latter inclined according to the present invention, are directed onto a region to be inspected of wafer 2 in the region of its wafer edge 23. A wafer underside illumination device 22 illuminates wafer 2 from below. The image data acquired by imaging device are transferred via a data line 16 to a data readout device 17. The latter is embodied, in the present case, as a computer.

The apparatus according to the present invention for wafer inspection can be incorporated into the production process as a separate inspection unit. It is also conceivable, however, to integrate the apparatus according to the present invention into an already existing wafer inspection system. An automated handling device for semi-automatically or automatically placing wafers 2 to be inspected into the apparatus and later removing them therefrom is provided, for example, for that purpose.

### PARTS LIST

1 Apparatus for wafer inspection

2 Wafer

3 Receiving device

4 Vacuum line

5 Incident-light illumination device

6 Light guide bundle

7 Light source

8 Displaceable support element

9 Imaging device

10 Imaging axis

11 Incidence point

12 Wafer normal line

13 Image plane

14 Illumination axis

15 Support rail

16 Data line

17 Data readout device

18 Objective

19 Camera

20 Stand

21 Alignment rail

22 Wafer underside illumination device

23 Wafer edge

24 α-adjustment device

25 Γ-adjustment device

α Illumination angle

β Imaging angle

γ Dark-field angle

1. An apparatus for wafer inspection comprising:
an incident-light illumination device having an illumination axis; and
an imaging device having an imaging axis;
wherein the illumination and imaging axes are inclined with respect to each other and directed onto a region to be inspected of a surface of a wafer, the illumination and imaging axes defining an image plane spanned by the illumination and imaging axes in a bright-field illumination setting of the apparatus, the illumination axis being rotatable out of the image plane to a dark-field angle so as to provide a dark-field illumination in the region to be inspected.

2. The apparatus as recited in claim 1 wherein the illumination axis and the imaging axis intersect at an incidence point of the imaging axis on the wafer.

3. The apparatus as recited in claim 1 wherein the imaging plane is orthogonal with respect to the wafer surface.

4. The apparatus as recited in claim 2 wherein the imaging plane is orthogonal with respect to the wafer surface.

5. The apparatus as recited in claim 4 wherein the imaging axis extends collinearly with a wafer normal line defined through the incidence point.

6. The apparatus as recited in claim 4 wherein the imaging axis is inclined at an imaging angle with respect to a wafer normal line defined through the incidence point.

7. The apparatus as recited in claim 6 wherein the illumination axis is inclined at an illumination angle with respect to the wafer normal line, the illumination angle being equal to the imaging angle.

8. The apparatus as recited in claim 1 wherein the dark-field angle has a range of from 0° to 50°.

9. The apparatus as recited in claim 1 wherein the incident-light illumination device in inclinable from a center region of the wafer toward an edge of the wafer so as to provide the dark-field illumination.

10. The apparatus as recited in claim 1 wherein the illumination device includes a polychromatic light source.

11. The apparatus as recited in claim 1 wherein the illumination device includes a monochromatic light source.

12. The apparatus as recited in claim 1 wherein the imaging device includes an objective and a camera.

13. The apparatus as recited in claim 1 wherein the imaging device includes an objective and a linear camera.

14. The apparatus as recited in claim 13 wherein the region to be inspected is at an edge of the wafer, and further comprising a wafer underside illumination device disposed beneath the edge of the wafer and configured to illuminate beyond the edge from below the edge.

15. The apparatus as recited in claim 14 further comprising a receiving device rotatable about a vertical axis thereof and configured for placement of the wafer.

16. The apparatus as recited in claim 15 further comprising a motorized drive system configured to rotate the receiving device.

17. The apparatus as recited in claim 15 further comprising:
a data readout device configured to sequentially read out image data of the linear camera during a rotational motion of the wafer; and
a computer configured to control the data readout device.

18. The apparatus as recited in claim 17 wherein, the computer is configured, after a rotation of the wafer through at least 360°, to determine, using the sequentially read out image data, at least one of a quality, a dimension and a location of an edge of an edge-bead-removed photoresist layer relative to the edge of the wafer.

19. The apparatus as recited in claim 17 wherein the computer is configured to determine, using the sequentially read out image data, a location of a flat on the edge of the wafer.

20. The apparatus as recited in claim 17 wherein the computer is configured to determine, using the sequentially read out image data, a location of a notch on the edge of the wafer.
